(19) United States
(12) Patent Application Publication
(10) Pub. No.: US 2012/0280495 A1
(43) Pub. Date: Nov. 8, 2012

(54) CERAMIC-TO-METAL FLANGE CONNECTION

(75) Inventors: Moshe Ben-Reuven, Princeton, NJ (US); Bruno E. Araujo, Brooklyn, NY (US)

(73) Assignee: Primus Green Energy Inc., Hillsborough, NJ (US)

(21) Appl. No.: 13/102,317

(22) Filed: May 6, 2011

(51) Int. Cl. F16L 23/24

(52) U.S. Cl. 285/368

(57) ABSTRACT

This invention describes a flanged connection or attachment joint between two coaxial, cylindrically-shaped members having different thermal coefficients of expansion, the connection/attachment being suitable for use in high temperature fluid transport.

### BACKGROUND OF THE INVENTION

1. Field of the Invention

The invention relates to jointed pipe connections and joining pipes used in light, medium, and heavy duty fluid transport operations, and in particular a flanged joint connection for connecting non-metallic and metallic pipe sections together where the non-metallic material cannot be welded.

2. Description of the Related Art

A typical metal flange connection used to join two separate metallic pipe sections includes a flange disc attached to the first pipe section, and a flange disc attached to the second pipe section. The flanges each have an inner circumferential surface, an outer circumferential surface, an inner face closest to the end of the pipe section, and an outer face opposite the inner face. The inner circumferential surface of a flange disc is selected to be approximately the same as the outer circumference of the pipe section to which it is to be attached. It is firmly attached to the pipe section by, for example, screwing, welding or being soldered on. The two inner faces of the first and second flange discs thus attached are then axially aligned with each other and clamped together using bolts or other fasteners, which causes the ends of the pipe sections to be pressed against each other in a tight manner. A gasket made of a deformable or elastomeric material suitable for the environment in which it operates is generally placed between the flange faces to provide the fluid-tight seal.

Though welding and soldering a flange disc to a metallic pipe is relatively simple, attaching a flange disc to a non-metallic pipe is generally a very complex process due to several disadvantages inherent in the use of different materials. For example, a glass, typically quartz glass or ceramic material, has a different thermal coefficient of expansion compared to, a metallic material, for example cast iron or steel. As taught in U.S. Pat. No. 4,349,203, under thermal loading—due to increase in temperature—the substantially different thermal coefficients of expansion of glass or ceramic and of metal have the tendency to cause fracture of the glass or ceramic element which is essentially brittle. The fracture, or failure of the flange connection, is due to the increased tension in the glass or ceramic material. Moreover, due to manufacturing constraints, it is difficult to achieve relative circularity in a cast or molded ceramic pipe or tube, resulting in significant deviations from concentricity in mated components, when compared to all-metal piping, tubing, and fittings. Moreover, it is not practical to simply seal a ceramic pipe or tube to a metal flange with traditional bolt fasteners, because the torque required to ensure a proper seal with a gasket would damage the ceramic (due to its relative brittleness).

U.S. Pat. No. 4,349,203 discloses a butt-type mating connection of two dissimilar material pipe sections. On the non-metallic (ceramic or glass) pipe section is formed a beveled or conical edge at the end of the pipe, which is inserted inside a larger diameter mating end of a metallic pipe having a corresponding angled surface. When heated, the non-metallic pipe end expands in its axial direction causing the beveled/angled end of the non-metallic pipe to be compressed inwardly (i.e., in the radial direction), imparting a hoop stress at the tip. Since glass and ceramic materials are inherently brittle, such a compression is preferred to tension. A compression-induced hoop stress is acceptable for attaining proper seating of a gasket system, whereas tension can cause failure. The invention shown, however, would be difficult to manufacture, and therefore costly to implement. It also does not provide for a standard flange connection to a metal flange, like the present invention does.

U.S. Pat. No. 4,552,386 shows a flanged connection between two axially-aligned, cylindrical pipe sections—one metallic and one non-metallic. The arrangement provides for radial expansion of the mating flanges relative to each other when they are coupled together with bolts. The flanges are shown as being integral to the respective ends of the two members. A separate ring member, through which the bolts pass, provides for thermal expansion without reducing the compressive axial load provided by the bolts. The invention suffers from several problems, not the least of which is that a gasket or “strain pad” is exposed to high temperature fluids inside the pipes due to a gap between the ends of the pipe sections, probably to account for axial expansion during heating.

U.S. Pat. No. 7,566,080 shows a flanged pipe joint having a first flange made of a first material and having an inwardly-facing female mating surface, and a second flange made of a second material and having an outwardly-facing male mating surface configured to mate with the female mating surface of the first flange. In between, a sealing ring is positioned between the female mating surface and the male mating surface with a gap between the inner and outer surfaces that enables the inner and outer surfaces to flex toward or away from each other. The second material expands relative to the first material when the temperature of the connection is changed from a temperature at which the connection is made to an operating temperature. The sealing ring is configured to flex and to thereby elastically apply contact pressure between the sealing ring and each of the male and female mating surfaces. The sealing ring may be an O-ring, or have a tapered design so that pressurization of the connection increases the contact pressure between the flanges and the sealing ring. The sealing ring may also be designed so that the contact surfaces can flex and thereby maintain desirable levels of contact pressure between the contact surfaces and the mating surfaces of the flanges. The seal ring may be made from a metallic material or an elastic or malleable material. The seal ring does not impart any significant stress on the male and female mating surfaces, but is designed rather to fill the gap between the two surfaces as their respective shapes, and hence the gap formed between them, differentially change due to thermal expansion.

What is needed, therefore, is a device to connect a non-metallic (e.g., ceramic) pipe section to a metallic pipe section that overcomes the problems and disadvantages inherent in the prior art flanged joint connections.

### BRIEF SUMMARY OF THE INVENTION

In accordance with the present invention, a device for joining or connecting a ceramic (or other non-metallic) pipe or tube section to a metallic pipe or tube section via a flanged connection is described. The apparatus permits the flanged connection of pipes where one or both of the pipe sections are made from materials that cannot accept a weld. In doing so, a standard flange disc may be attached and the sealing of the disc to the outer circumferential surface of the pipe may be achieved, thereby providing a standard flanged connection for mating with a standard metallic pipe flange.

The apparatus of the present invention includes inner and outer flange rings or discs which, when fastened together, compress a seal packing in an axial direction, causing it to expand laterally and press against the outside circumferential surface of the non-metallic pipe. The outer flange ring can thereby be made to specifications compatible with a standard flange discs, or bored and welded to a standard fitting (e.g., flange). The apparatus may then slide over the non-metallic conduit and can be secured relative to the conduit, thereby providing a universal interface to standard connections. With the use of a compressible, thermally resistant, gland or packing that deforms under compression in the plastic regime to conform to the often odd-shaped space between metal flange/seal unit and the outer ceramic surface of the tube, a suitable connection can be made. The apparatus secured relative to the ceramic tubing may thus provide a metal surface for bolting to metal components.

As used in this description, “pipe,” “tube,” and/or “conduit” may be used interchangeably and considered synonymous terms, though the term “pipe” is used more frequently herein for simplicity to describe the various embodiments of the present invention. As described, a pipe, tube, or conduit includes an inner surface and an outside or outer surface. The present invention is not limited solely to pipes with perfectly circular or cylindrical cross-sections, but may be applied to non-circular, irregular-shaped, or other geometric shapes.

It is therefore an object of the present invention to provide a flange connection of the generic type which can be used for metal-to-ceramic joint connections, that are relatively simple to produce, handle, and install, which eliminate the disadvantages of flanged pipe connections known in the prior art.

Briefly described, those and other objects and advantages of the present invention are accomplished, as embodied and fully described herein, by an apparatus for connecting pipe sections in a substantially co-axially manner, the apparatus including a first flange disc having a circumferential neck portion extending axially from one face of the first flange disc and forming a substantially circular axially-aligned pipe-receiving opening for receiving the end of a first pipe section. The apparatus also includes a second flange disc having a circumferential neck portion extending axially from one face of the second flange disc and forming a substantially circular axially-aligned pipe-receiving opening for receiving the end of a second pipe section, wherein the neck portions of the first and second flange discs overlap when the discs are mated to each other. The apparatus includes a means for reversibly connecting the first and second flange discs to each other, such as a bolt or other type of fastener. The apparatus also includes a deformable seal arranged on at least a portion of the inside surface of the first flange disc and co-axially with the first and second flange discs, wherein the seal is adapted to deform radially inwardly upon connecting the first and second flange discs together.

The connecting apparatus further includes a gasket arranged co-axially with the second flange disc. The seal may be made from an elastomeric material. The inner circumferential diameter of the seal may be less than the diameter of the pipe-receiving opening. The second flange disc may be welded to the second pipe section.

### BRIEF DESCRIPTION OF THE DRAWINGS

Those and other objects, advantages, and features of the invention, as well as the invention itself, will become more readily apparent from the following detailed description when read together with the following drawings, in which:

FIG. 1 is a schematic drawing of a plan view of a flange connection according to one embodiment of the present invention;

FIG. 2 is a schematic drawing of an elevation view of the flange connection shown in FIG. 1;

FIG. 3 is a schematic drawing of the cross-section “A-A” of the flange connection shown in FIG. 1; and

FIG. 4; is a schematic drawing of detail “B” of the flange connection shown in FIG. 1.

### DETAILED DESCRIPTION OF THE INVENTION

Several preferred embodiments of the present invention are described for illustrative purposes, it being understood that the invention may be embodied in other forms not specifically shown in the drawings. The figures will be described with respect to the structure and functions that achieve one or more of the objects of the invention and/or receive the benefits derived from the advantages of the invention as understood by persons skilled in the art or explicitly set forth herein.

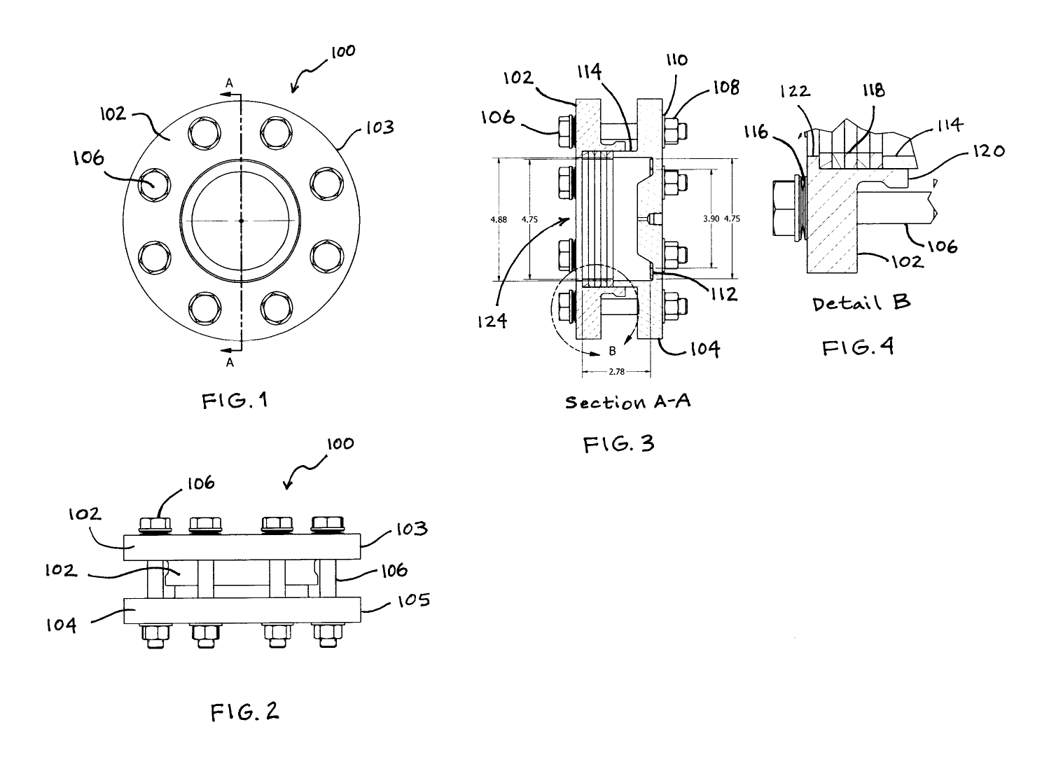

Turning first to FIG. 1, shown therein is a schematic drawing of a plan view of a flange connection 100 according to one embodiment of the present invention. The particular embodiment of the invention shown reveals that flange connection 100 has a first flange disc 102 and circumferentially spaced apart bore holes for accepting fasteners, such as the heavy duty hex bolts 106 shown. The first flange disc 102 has a circular-shaped outer surface 103.

Turning next to FIG. 2, shown therein is a schematic drawing of an elevation view of the flange connection 100 shown in FIG. 1. The drawing is obviously of an installed or assembled configuration of the invention. One of ordinary skill in the art will appreciate that the component parts described and shown may be disassembled and separated from each other, and then reassembled again. Thus, the first flange disc 102 may be separated from the second flange disc 104 by first removing the bolts 106 and then separating the discs from each other. The second flange disc 104 has a circular-shaped outer surface 105, like the first flange disc 102. The discs 102, 104, in their installed or assembled configuration, are co-axially aligned with each other and have roughly the same outside diameter.

Turning now to FIG. 3, shown therein is a schematic cross-sectional drawing of the flange connection 100 taken along slice “A-A” (as shown in FIG. 1). In the embodiment shown, the first flange disc 102 is connected to the second flange disc 104 using several spaced-apart bolts 106. Each bolt is fastened using a suitable hex nut 108 (such as, for example, an ANSI B18.2.2, ⅝-inch nut), a plain washer 110 (such as, for example, an ANSI B.18.22.1, ⅝-inch narrow Type A or B washer), and a spring washer 116 (as seen in FIG. 4).

The second flange disc 104 includes a flange neck 114 (such as, for example, ASME B16.5, flange welding neck, class 150-6), which continuously and circumferentially extends around the second flange disc 104 and protrudes axially from the inner face of the second flange disc 104 thereby forming a male connecting part.

In the embodiment of the invention show, the circumferential inner surface of the first disc 102 has a diameter of 4.88 inches, and the circumferential inner surface of the second disc 104 has a diameter slightly larger than 4.75 inches. Seated co-axially inside the second flange disc 104 is a non-metallic, flat gasket 112, which may have the following dimensions: 3.9-inch ID, 4.75-inch OD, 1/16-inch thick.

Turning now to FIG. 4, shown therein is a schematic drawing of the Detail “B” portion of FIG. 3 in which a portion of the flange connection 100 is shown in more detail. As shown, the first flange disc 102 includes a flange welding neck 120, which continuously and circumferentially extends around the first flange disc 102 and protrudes axially from the inner face of the first flange disc 102. The diameter of the circumferential inside surface of the flange neck 120 is slightly larger than the outside diameter of the flange neck 114 so that when the first flange disc 102 and the second flange disc 104 are in an assemble or installed configuration, like that shown in the drawing, the surfaces of the two necks 114, 120 are in tight contact with each other. The outside face of the first flange disc 102 includes a lip 122 that extends part way into the circular opening 124 (as best seen in FIG. 3).

Between the lip 122 and the end of the flange neck 114 is a space for a solid cuff seal 118, which is generally tubular or cylindrically shaped. The seal 118 has a thickness slightly greater than the thickness of the flange neck 114 and the height of the lip 122 so that it has an inside diameters of 4.75 inches (in the specific embodiment shown). The seal 118 is made of a compressible, thermally-resistant material that deforms (expands) radially inwardly when under axial compression due to the tensioning of the bolts 106. Deformation of the seal in other directions is restricted due to the lip 122, the end of the flange neck 114, and the inner surface of the flange neck 120 upon which the seal 118 is in contact.

For lower temperature duty, those of ordinary skill in the art will appreciate that the seal 118 may be made of any material suitable for the conditions and uses of the seal. For higher temperature duty, the seal 118 may be made of a graphic-based material.

The amount of radial (inward) deformation of the seal 118 depends on the size of the seal 118, the material of construction, and how close the first and second discs 102, 104 are brought together. The closer the discs 102, 104 are brought together (i.e., by further tightening of the nuts 108), the more the end of the flange neck 114 compresses against the side of the seal 118 (which is pinned against the lip 122 on its other side). The increasing radial (inward) deformation causes the seal material to conform to the often odd-shaped space between the flange/seal and the outer surface of the non-metallic pipe (not shown) when it is inserted into the opening 124. The close contact between the seal 118 and the inserted pipe also forms a fluid-tight connection during high temperature operations without imparting any tensile or tension forces on the non-metallic pipe.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

I/We claim:

1. An apparatus for connecting pipe sections substantially co-axially comprising:
a first flange disc having a circumferential neck portion extending axially from one face of the first flange disc and forming a substantially circular axially-aligned pipe-receiving opening for receiving the end of a first pipe section;
a second flange disc having a circumferential neck portion extending axially from one face of the second flange disc and forming a substantially circular axially-aligned pipe-receiving opening for receiving the end of a second pipe section, wherein the neck portions of the first and second flange discs overlap when the discs are mated to each other;
means for reversibly connecting the first and second flange discs; and
a deformable seal arranged on at least a portion of the inside surface of the first flange disc and co-axially with the first and second flange discs, wherein the seal is adapted to deform radially inwardly upon connecting the first and second flange discs together.

2. The connecting apparatus according to claim 1, further comprising a gasket arranged co-axially with the second flange disc.

3. The connecting apparatus according to claim 1, wherein the seal is made from an elastomeric material.

4. The connecting apparatus according to claim 1, wherein the inner circumferential diameter of the seal is less than the diameter of the pipe-receiving opening.

5. The connecting apparatus according to claim 1, wherein the means for reversibly connecting the first and second discs comprises a plurality of bolts and bolt-receiving bore holes on the first and second discs.

6. The connecting apparatus according to claim 1, wherein the second flange disc is adapted to being welded to the second pipe section.

7. A joint for connecting pipe sections comprising:
a first non-metallic pipe section having a connecting end;
a second metallic pipe section having a connecting end;
a first flange disc having a circumferential neck portion extending axially from one face of the first flange disc and forming a substantially circular axially-aligned pipe-receiving opening for receiving the end of the first pipe section;
a second flange disc having a circumferential neck portion extending axially from one face of the second flange disc and forming a substantially circular axially-aligned pipe-receiving opening for receiving the end of the second pipe section, wherein the neck portions of the first and second flange discs overlap when the discs are mated to each other;
means for reversibly connecting the first and second flange discs; and
a deformable seal arranged on at least a portion of the inside surface of the first flange disc and co-axially with the first and second flange discs, wherein the seal is adapted to deform radially inwardly upon connecting the first and second flange discs together and thereby contacting an outer surface of the first pipe section.

8. The pipe joint according to claim 7, wherein first pipe section is a ceramic pipe.

9. The pipe joint according to claim 7, wherein the second flange disc is attached to the second pipe section.

10. The pipe joint according to claim 7, wherein the second flange disc is welded to the second pipe section.

11. The pipe joint according to claim 7, further comprising a gasket arranged co-axially with the second flange disc.

12. The pipe joint according to claim 7, wherein the seal is made from an elastomeric material.

13. The pipe joint according to claim 7, wherein the inner circumferential diameter of the seal is less than the diameter of the pipe-receiving opening.

14. The pipe joint according to claim 7, wherein the means for reversibly connecting the first and second discs comprises a plurality of bolts and bolt-receiving bore holes on the first and second discs.
